(19) United States
(12) Patent Application Publication
(10) Pub. No.: US 2016/0185626 A1
(43) Pub. Date: Jun. 30, 2016

(54) DESALINATION METHODS AND SYSTEMS

(71) Applicant: Phoenix Revolution Inc., Boston, MA (US)

(72) Inventor: Casey Glynn, Boston, MA (US)

(73) Assignee: Phoenix Revolution Inc., Boston, MA (US)

(21) Appl. No.: 14/797,905

(22) Filed: Jul. 13, 2015

Related U.S. Application Data
(60) Provisional application No. 62/023,936, filed on Jul. 13, 2014.

(51) Int. Cl. C02F 1/44; C02F 1/00; C02F 1/32

(52) U.S. Cl. CPC C02F 1/441; C02F 1/325; C02F 1/008; C02F 2101/10

(57) ABSTRACT

Methods and systems are disclosed for desalinating saltwater. The method includes (a) drawing feed water from a body of saltwater at a given depth below the surface of the body of saltwater; (b) transporting the feed water to one or more reverse osmosis vessels submerged in the body of saltwater and located a depth greater than the given depth at which the feed water is drawn in step (a); (c) controllably desalinating the feed water in the one or more reverse osmosis vessels to produce freshwater and brine concentrate such that the salinity of the brine concentrate is substantially the same as the salinity of the saltwater in the body of saltwater at a predetermined depth below the surface of the body of saltwater; and (d) discharging the brine concentrate into the body of saltwater at the predetermined depth below the surface of the body of saltwater.

### CROSS REFERENCE TO RELATED APPLICATION

This application claims priority from U.S. Provisional Patent Application No. 62/023,936 filed on Jul. 13, 2014 entitled Ocean Pure Water System, which is hereby incorporated by reference.

### BACKGROUND

The present application relates generally to methods and systems for decontaminating and desalinating water sources such as, e.g., seawater, brackish water, or chemically or physically contaminated water.

### BRIEF SUMMARY OF THE DISCLOSURE

A method of desalinating saltwater in accordance with one or more embodiments comprises the steps of: (a) drawing feed water from a body of saltwater at a given depth below the surface of the body of saltwater; (b) transporting the feed water drawn in step (a) to one or more reverse osmosis vessels submerged in the body of saltwater and located a depth greater than the given depth at which the feed water is drawn in step (a); (c) controllably desalinating the feed water in the one or more reverse osmosis vessels to produce freshwater and brine concentrate such that the salinity of the brine concentrate is substantially the same as the salinity of the saltwater in the body of saltwater at a predetermined depth below the surface of the body of saltwater; and (d) discharging the brine concentrate into the body of saltwater at the predetermined depth below the surface of the body of saltwater.

A desalination system for desalinating saltwater in a body of saltwater in accordance with one or more embodiments includes an input pipe adapted to draw feed water from the body of saltwater at a given depth below the surface of the body of saltwater. One or more reverse osmosis vessels are coupled to the input pipe for receiving feed water drawn into the input pipe and desalinating the feed water to produce freshwater and brine concentrate. The one or more reverse osmosis vessels are submersible in the body of saltwater at a given depth greater than the given depth below the surface of the body of saltwater at which the feed water is drawn into the input pipe. The system also includes one or more input pumps coupled to the input pipe and the one or more reverse osmosis vessels for transporting the feed water through the input pipe to the one or more reverse osmosis vessels. A freshwater outlet coupled to the one or more reverse osmosis vessels outputs the freshwater from the one or more reverse osmosis vessels. One or more output pumps coupled to the freshwater outlet transport the freshwater from the reverse osmosis vessels. A brine outlet coupled to the one or more reverse osmosis vessels discharges the brine concentrate into the body of saltwater. A control system controllably desalinates the feed water in the one or more reverse osmosis vessels such that the salinity of the brine concentrate is substantially the same as the salinity of the saltwater in the body of saltwater at the brine outlet.

### BRIEF DESCRIPTION OF THE DRAWINGS

FIG. 1 is a simplified block diagram illustrating an exemplary desalination system in accordance with one or more embodiments.

FIGS. 2A and 2B are front and side views, respectively, of an exemplary desalination system in accordance with one or more embodiments.

FIGS. 3A and 3B are perspective and top views, respectively, of an alternative exemplary desalination system in accordance with one or more embodiments.

FIGS. 4A and 4B are simplified flow diagrams illustrating an exemplary operation of a desalination system in accordance with one or more embodiments.

FIG. 5 is a simplified block diagram illustrating select components of an exemplary desalination system in accordance with one or more embodiments.

FIG. 6 is a simplified diagram illustrating an exemplary reverse osmosis vessel in accordance with one or more embodiments.

FIG. 7 is a simplified diagram illustrating an exemplary heat exchanger for transferring heat from the motor of an input pump to an output freshwater line in accordance with one or more embodiments.

FIG. 8 is a top view showing a reverse osmosis vessel including a plurality of tubular semipermeable membranes in accordance with one or more embodiments.

### DETAILED DESCRIPTION

Briefly and as will be described in further detail below, various embodiments disclosed herein are directed to a desalination system designed to operate submerged in a body of saltwater such as a well or an ocean. The system desalinates saltwater to produce freshwater, which is transported to a water grid or a location where it can be further processed or used. Brine concentrate, which is produced as a byproduct, is discharged into the body of saltwater. The desalination process is computer controlled so that the salinity of the brine concentrate is substantially the same as the salinity as the saltwater in the body of water at a depth where it is discharged to minimize any ecological impact of the brine discharge. Saltwater is drawn into the system from a location closer to the surface of the body of saltwater where the saltwater has relatively lower salinity. The desalination system is compact and has an interlinking modular design that enables the system to be quickly and easily scaled up or down. The system is mass producible and cost-effective, and can be attached to existing or future water grids.

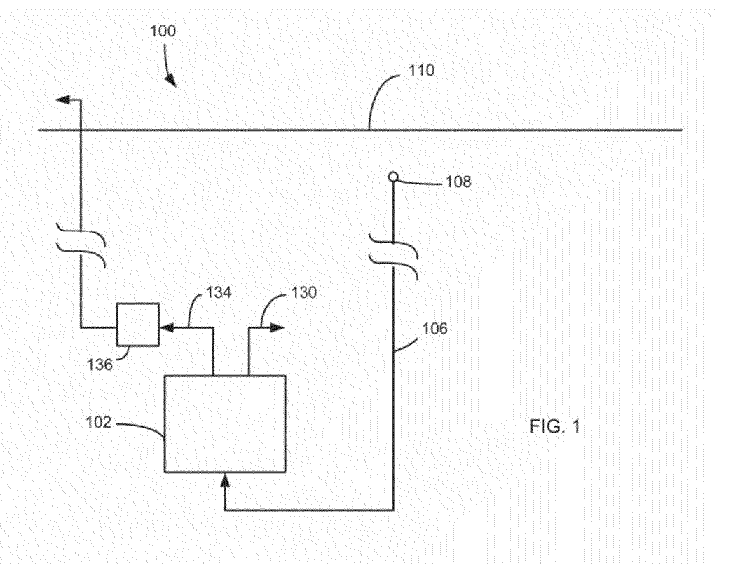

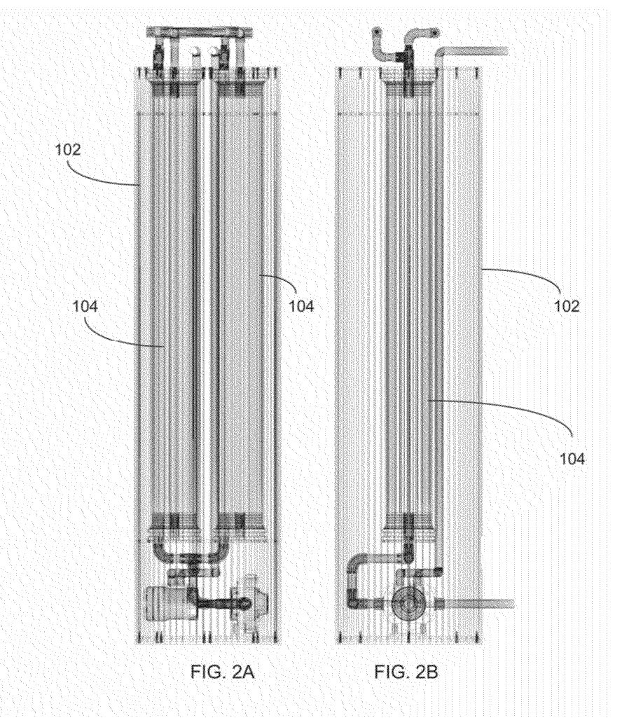

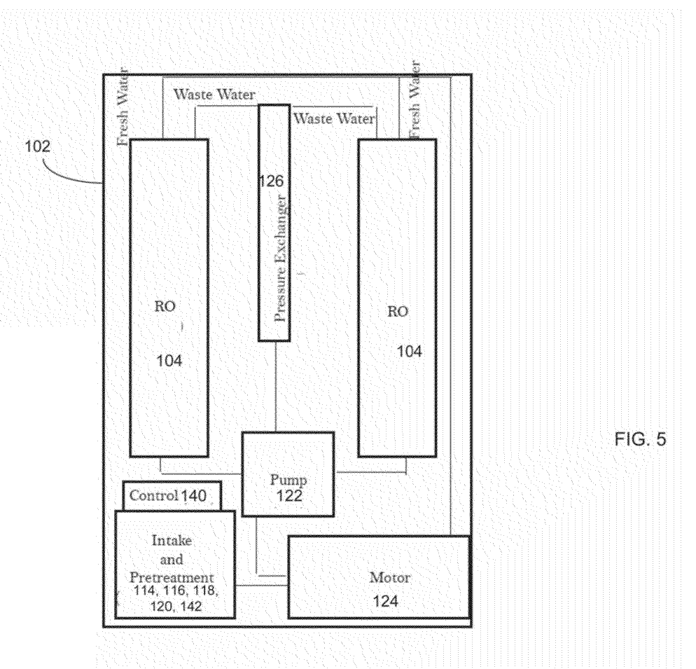

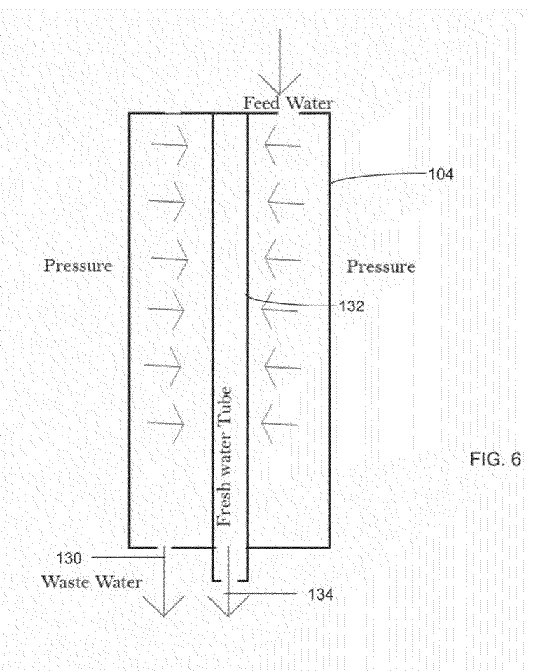

FIGS. 1-8 illustrate an exemplary desalination system 100 in accordance with one or more embodiments. The system includes a containment enclosure 102, which is designed to hold a plurality of reverse osmosis vessels 104 that operate in parallel or in series to desalinate feed water. One or more feed pipes 106 provide feed water to the reverse osmosis vessels.

Feed water is drawn from the body of saltwater at a water intake valve 108 at the intake end of each of the one or more feed pipes. The feed water is drawn from the body of saltwater at a shallower depth in the body of saltwater than the depth of the reverse osmosis vessels where the brine concentrate is discharged. In one exemplary embodiment, the feed water is drawn at or near the surface 110 of the body of water, e.g., 10-15 feet below the surface, and the reverse osmosis vessels are positioned at a deeper depth, e.g., 50-100 feet below the surface.

The feed pipes 106 act as a salinity insulator for the input feed water. Saltwater near the surface of the body of water has lower salinity since denser saltwater sinks to lower depths in the body of water. By way of example, the salinity of the water at the surface of the body of water may be 30-32 ppm, while the salinity of water 100 feet below the surface may be 33-34 ppm. The low point salinity feed water is pushed via hydrostatic pressure through the feed pipes to the reverse osmosis vessels.

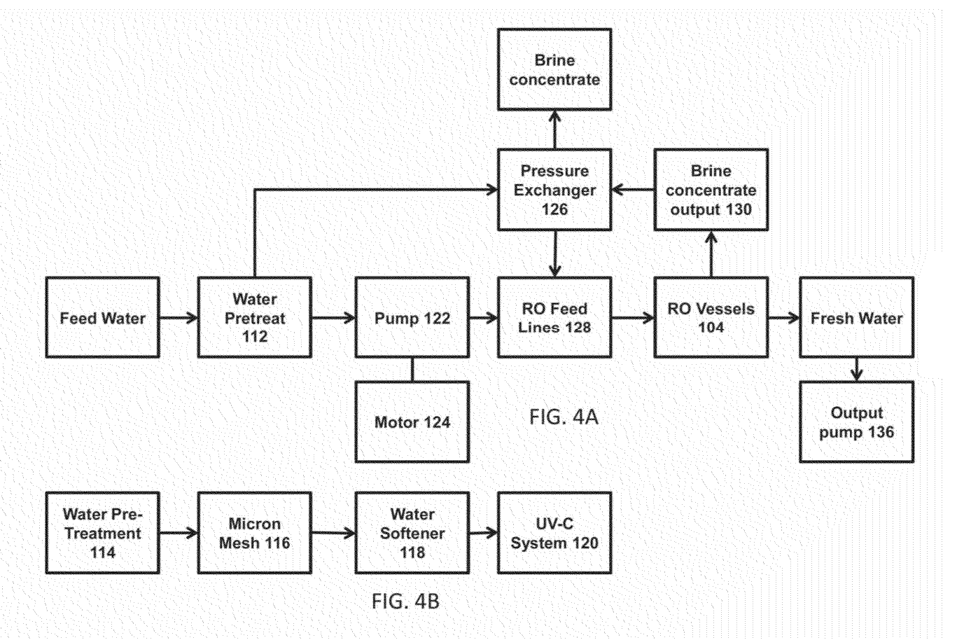

As illustrated in the exemplary flow diagrams of FIGS. 4A and 4B, the feed water flows through a water pretreat process 112 (shown in greater detail in FIG. 4B). A pretreatment filter 114 is used to remove small objects at the inlets of the feed pipes. The pretreatment filter operates generally on the same principles as a settling chamber. The housing of the intake pipe is designed for water to follow the low pressure up into the pipe, while gravity removes waste. The intake pipe also has a perforated stainless steel sheet 116 with small holes (e.g., 0.5 micron diameter holes). These holes, which are mere microns in diameter, allow for the flow of water therethrough, but block out a substantial portion of suspended solids (e.g., 99% of suspended solids).

A water softener 118 may be used to soften the feed water by removing calcium, magnesium, and certain other metal cations in hard water. The resulting soft water is more compatible with and extends the lifetime of plumbing and protects reverse osmosis membranes from these chemicals.

The system also includes a UV-C (ultraviolet C) decontamination system 120 to decontaminate the feed water flowing into the reverse osmosis vessels. The UV-C decontamination system includes a UV-C light source (e.g., a germicidal lamp) for exposing the feed water to UV-C light radiation to decontaminate the feed water of microbes and other organic materials.

The feed water is then released to one or more main pumps 122 driven by one or more motors 124 that add energy to the system before the reverse osmosis vessels.

A pressure exchanger 126 is used to transfer excess pressure from the brine concentrate output 130 to reverse osmosis feed lines 128 from the pump 122 to the reverse osmosis vessels 104.

The feed water flows through the reverse osmosis vessels, which desalinate the water. FIG. 6 is a simplified block diagram illustrating an exemplary reverse osmosis vessel 104 in accordance with one or more embodiments. The vessel 104 includes a tubular semipermeable membrane 132. Water is pushed through the semipermeable membrane 132 to remove dissolved solids such as salts and contaminants from the water. Freshwater leaves the vessel at freshwater outlet 134. Brine concentrate leaves the vessel at outlet 130.

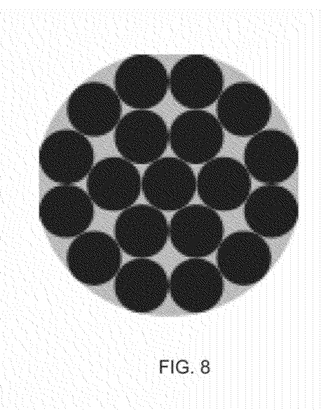

In accordance with one or more embodiments, each reverse osmosis vessel includes a plurality of tubular semipermeable membranes operating in series or in parallel. FIG. 8 is a top view of a set of tubular semipermeable membranes in a reverse osmosis vessel in a hexagonal lattice arrangement.

The brine concentrate produced as a byproduct in the reverse osmosis vessels is released into the body of water through one or more release check valves at a brine outlet 130 in the containment enclosure. The brine concentrate has substantially the same salinity as the water in the body of water where it is discharged. In one exemplary embodiment, the salinity of the brine concentrate is within 20% of the salinity of the body of water where it is discharged. This causes no substantial rise in local salinity levels and requires no pretreatment of the brine concentrate before being discharged from the system.

The fresh water produced by the one or more reverse osmosis vessels leaves the system via one or more isolated freshwater outlets 134. The system includes one or more output pumps 136 for pumping the fresh water to the surface or to the piping system of a water grid using, e.g., a flanged piping connector.

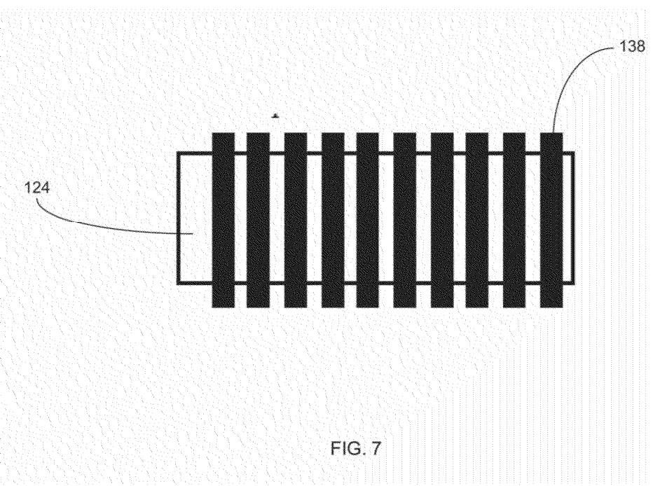

This system further includes a heat exchanger 138 shown in a simplified drawing in FIG. 7 for transferring heat from one or more motors 124 to the freshwater output by the reverse osmosis vessels.

The desalination system also includes a control system 140 to controllably desalinate the feed water in the one or more reverse osmosis vessels such that the salinity of the brine concentrate is substantially the same as the salinity of the saltwater in the body of saltwater at the brine outlet. In the reverse osmosis vessels, the water is pushed through a semipermeable membrane 132 to remove dissolved solids such as salts and contaminants from the water. The system is based on the natural osmosis threshold for varying levels of contaminates or salinity. The higher the salinity of the feed water, the more pressure is needed to push the water through the membrane. This additional pressure that is supplied over the threshold increases the amount of flow through the membrane. Also, the salt concentration levels in the feed water rise as fresh water is removed from the original flow.

The system includes salinity sensors 142 to measure the feed water salinity levels. By way of example, the salinity sensors can comprise conductivity meters for measuring water conductivity, which can be converted to salinity. Data from the sensors is sent to a computer controller in the control system. The controller includes one or more microprocessors or equivalent programmed to process the incoming salinity level data as well as data on the salinity level in the body of water where the brine concentrate is to be discharged. (The controller can, e.g., receive water conductivity data and convert the data to salinity.) In one exemplary embodiment, the controller comprises an Arduino microcontroller. The controller is programmed to determine a desired pressure level in the RO vessel and control the pressure limit in an inline relief valve accordingly, which can increase or decrease the pressure in the membrane vessel, thereby increasing or decreasing the extraction rate of fresh water from the feed water. In this way, the system can control the salinity levels of the brine concentrate such that it substantially matches the salinity levels within the body of water to reduce the ecological effects of the brine discharge and to meet any government regulations on brine concentrate discharges.

Various types of pumps may be used to transport feed water, freshwater, and brine concentrate including, by way of example, gear pumps, rotary vane pumps, screw pumps, bent axis pumps, in-line axial piston (swashplate) pumps, radial piston pumps, and peristaltic pumps, among others. The pumps may be driven by motors such as, e.g., electric motors, motors powered by natural gas, oil, petroleum, and diesel fuels, and hydro, saltwater, steam, magnet pumps. Electric motors include, but are not limited to permanent magnet DC motors, AC induction motors, brushless DC motors, and universal motors, among others.

In accordance with one or more embodiments, a biofilm removal process can be used to clean the feed pipes and the intake pretreatment filters. When in this cleaning mode, the main pumps are operated in a reverse mode such that water flows through the feed pipes in an opposite direction. The pumps add high pressure flow to “backflow clean” the feed pipes and the intake filter. Once the cleaning process has been completed, the pumps stop and the intake and output lines are reversed to resume normal operations.

Desalination systems and methods in accordance with various embodiments have a hydro static pressure advantage over conventional systems. Gravity feed pressure brings feed water from the water intake valve through the feed pipes to the main pumps of the system without additional energy consumption. Unlike conventional land-based desalination systems, there is no need to use large scale pumps to bring feed saltwater to a desalination system. The added pressure from system via the feed pipes to the pump can also reduce work load on the main pump system. For example, if fluid pressure at main pump inlet is 50 PSI and the pump adds 800 PSI to the system, the combined system will add to a greater head created by the pump. This added head can reduce energy consumption by the main pump and increase the energy output of the pumping system. The standard pressure drop from a reverse osmosis system may be negated by hydrostatic pressure of the ocean.

The UV-C decontamination process removes bacteria and other organisms using UV-C wave lengths without use of chlorine. This obviates the need to add and then remove chlorine as done in the pretreatment process of conventional desalination systems.

In accordance with one or more embodiments, the reverse osmosis containment enclosure uses a packing circles system to optimally place reverse osmosis vessels in the generally smallest area possible. The same technique can be used on a smaller or larger diameter enclosures and adjusted for larger or smaller diameter reverse osmosis vessels.

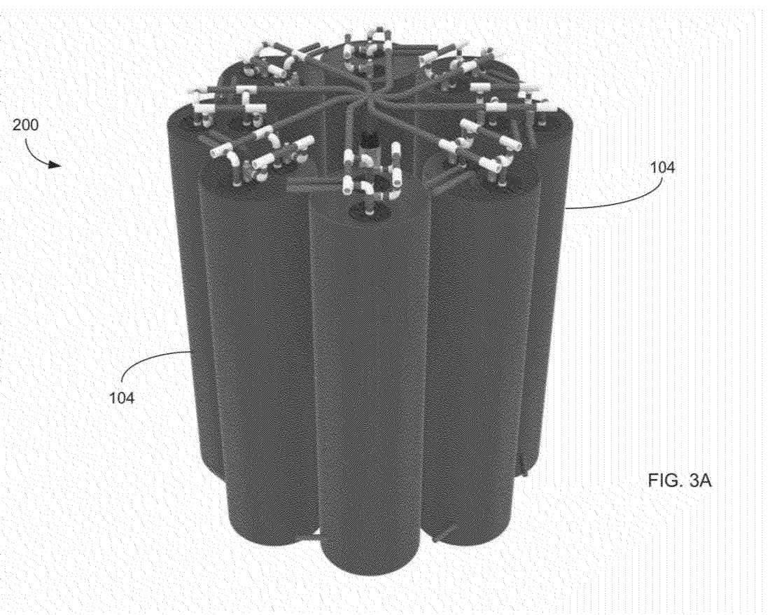

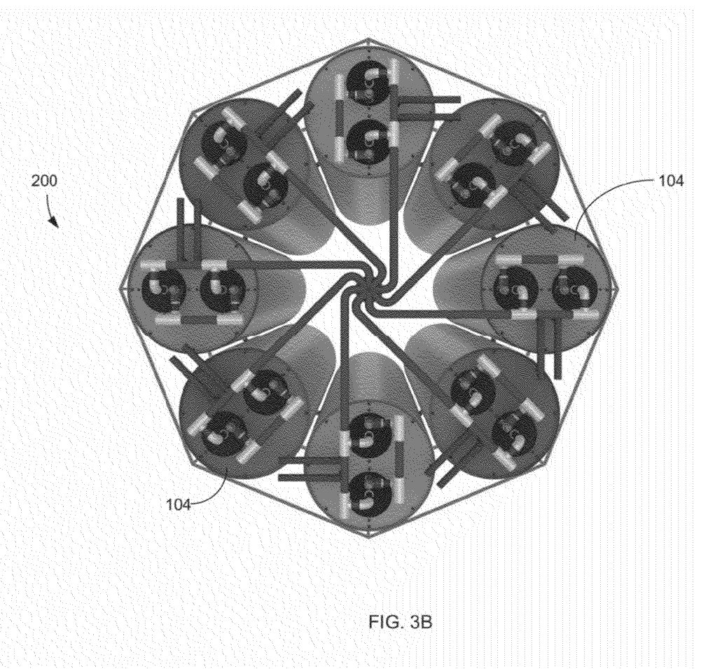

FIGS. 3A and 3B illustrate an alternative desalination system 200 in accordance with one or more embodiments including eight reverse osmosis vessels. FIG. 3B shows the hexagonal “honeycomb” structure, which enables scaling allowing for the highest density of units per area.

The reverse osmosis containment enclosure is sealed in various compartments to allow for full access on the ocean floor for operation and repairs.

In accordance with one or more embodiments, the reverse osmosis membrane vessels and containment enclosure are designed with quick release connections that allow for quick additions of membrane vessels and substitutions of under optimized membrane vessels. The system can also be cleaned without dismantling the entire system.

The heat exchangers provide for water cooled motors for the pumps used to transport the feed water, fresh water, and brine concentrate. Water cooled motors allow for smaller containers for the pumps. Water removes heat from system and keeps motors running at efficient temperatures.

The heating of the fresh water in the heat exchanger reduces the viscosity of the water. Lower viscosity water has a lower friction coefficient thus produces less friction and head loss while being transported. Lower head loss leads to lower power requirements for surface pumps.

In accordance with one or more embodiments, the desalination system is designed to interconnect with other like systems. For instance, each system can interlink with another system, doubling the fresh water output. Each of the systems can be interlinked with one or more pumps to increase efficiency or power usage. For example, fresh water output of each system may be combined through one water grid connected access. Interconnectivity allows for additional systems to be added in the future, as needed. Furthermore, interconnectivity allows for fluctuating water needs based on population or weather conditions like extreme drought. There is no requirement for a minimum or maximum number of units or output that can be generated.

In accordance with one or more embodiments, the system can be rapidly deployed. Each system is designed to be connected to existing and future water grids worldwide. The rapid deployability makes it an ideal disaster relief or rapidly deployable water desalination product that can move based on water needs or salinity levels.

The processes of the controller in the control system described above may be implemented in software, hardware, firmware, or any combination thereof. The processes are preferably implemented in one or more computer programs executing on the controller. Each computer program can be a set of instructions (program code) in a code module resident in the random access memory of the controller. Until required by the controller, the set of instructions may be stored in another computer memory or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions.

Accordingly, the foregoing description and attached drawings are by way of example only, and are not intended to be limiting.

What is claimed is:

1. A method of desalinating saltwater, comprising the steps of:
(a) drawing feed water from a body of saltwater at a given depth below the surface of the body of saltwater;
(b) transporting the feed water drawn in step (a) to one or more reverse osmosis vessels submerged in the body of saltwater and located a depth greater than the given depth at which the feed water is drawn in step (a);
(c) controllably desalinating the feed water in the one or more reverse osmosis vessels to produce freshwater and brine concentrate such that the salinity of the brine concentrate is substantially the same as the salinity of the saltwater in the body of saltwater at a predetermined depth below the surface of the body of saltwater; and
(d) discharging the brine concentrate into the body of saltwater at the predetermined depth below the surface of the body of saltwater.

2. The method of claim 1, wherein the salinity of the brine concentrate is within 20% of the salinity of the saltwater in the body of saltwater at the predetermined depth below the surface of the body of saltwater.

3. The method of claim 1, further comprising filtering the feed water as it is drawn in step (a).

4. The method of claim 1, further comprising decontaminating the feed water drawn in step (a) during step (b) by exposing the feed water to ultraviolet light.

5. The method of claim 4, wherein no chemicals are applied in decontaminating the feed water drawn in step (a) or freshwater produced by the reverse osmosis vessels.

6. The method of claim 1, wherein controllably desalinating the feed water in the one or more reverse osmosis vessels in step (c) comprises controlling pressure applied to the feed water in the one or more reverse osmosis vessels.

7. The method of claim 6, further comprising detecting the salinity of the feed water received at the one or more reverse osmosis vessels and accordingly adjusting pressure applied to the feed water in the one or more reverse osmosis vessels to increase or decrease the extraction rate of freshwater from the feed water and the salinity of the brine concentrate.

8. The method of claim 1, wherein step (b) is performed through an intake tube insulating the salinity of the feed water drawn in step (a) from the saltwater in the body of saltwater.

9. The method of claim 1, further comprising cooling one or more input pumps for pumping feed water through the one or more reverse osmosis vessels by transferring heat from the one or more pumps to the freshwater.

10. The method of claim 1, further comprising (e) transporting the freshwater from the reverse osmosis vessel to a water grid using one or more freshwater output pumps.

11. The method of claim 1, wherein the feed water comprises seawater or brackish water.

12. The method of claim 1, wherein the body of saltwater comprises an ocean or a well.

13. The method of claim 1, wherein the one or more reverse osmosis vessels comprise a plurality of reverse osmosis vessels operating in parallel or in series, each installed in a different one of a plurality of chambers within a containment enclosure, wherein the method further comprises increasing or decreasing desalination capacity by adding or removing one or more reverse osmosis vessels to or from the containment enclosure, respectively.

14. The method of claim 1, wherein the one or more reverse osmosis vessels operate in parallel or in series and are each installed in one of the plurality of chambers within one or more containment enclosures, wherein the method further comprises increasing or decreasing desalination capacity by adding or removing containment enclosures.

15. A desalination system for desalinating saltwater in a body of saltwater, comprising:
an input pipe adapted to draw feed water from the body of saltwater at a given depth below the surface of the body of saltwater;
one or more reverse osmosis vessels coupled to the input pipe for receiving feed water drawn into the input pipe and desalinating the feed water to produce freshwater and brine concentrate, said one or more reverse osmosis vessels being submersible in the body of saltwater at a given depth greater than the given depth below the surface of the body of saltwater at which the feed water is drawn into the input pipe;
one or more input pumps coupled to the input pipe and the one or more reverse osmosis vessels for transporting the feed water through the input pipe to the one or more reverse osmosis vessels;
a freshwater outlet coupled to the one or more reverse osmosis vessels for outputting the freshwater from the one or more reverse osmosis vessels;
a brine outlet coupled to the one or more reverse osmosis vessels for discharging the brine concentrate into the body of saltwater; and
a control system to controllably desalinate the feed water in the one or more reverse osmosis vessels such that the salinity of the brine concentrate is substantially the same as the salinity of the saltwater in the body of saltwater at the brine outlet.

16. The system of claim 15, further comprising a pretreatment filter at the inlet of the input pipe for removing particulates in the feed water received by the input pipe.

17. The system of claim 16, further comprising a cone filter cap at the inlet end of the input pipe including the pretreatment filter.

18. The system of claim 15, further comprising an ultraviolet light source for exposing the feed water to ultraviolet light for decontamination.

19. The system of claim 18, wherein the freshwater produced by the system is decontaminated without the use of chemicals.

20. The system of claim 15, further comprising a heat exchanger for cooling the one or more output pumps or the one or more input pumps by transferring heat from the one or more output pumps or the one or more input pumps to the freshwater or brine concentrate output by the one or more reverse osmosis vessels.

21. The system of claim 15, further comprising a containment enclosure including a plurality of chambers, each adapted to hold one of the one or more reverse osmosis vessels.

22. The system of claim 21, wherein the reverse osmosis vessels are removably secured in their respective chambers of the containment enclosure to facilitate insertion, removal, or substitution of the reverse osmosis vessels in the containment enclosure.

23. The system of claim 22, wherein the containment enclosure is connectable in parallel or in series to other containment enclosures to increase desalinization capacity of the system .

24. The system of claim 15, wherein the salinity of the brine concentrate is within 20% of the salinity of the saltwater in the body of saltwater at the predetermined depth below the surface of the body of saltwater.

25. The system of claim 15, wherein the control system controls pressure applied to the feed water in the one or more reverse osmosis vessels.

26. The system of claim 25, further comprising a sensor for detecting the salinity of the feed water received at the one or more reverse osmosis vessels, and wherein the control system adjusts pressure applied to the feed water in the one or more reverse osmosis vessels based on the detected salinity of the feed water to adjust the extraction rate of freshwater from the feed water and the salinity of the brine concentrate.

27. The system of claim 25, further comprising a relief valve controlled by the control system for adjusting pressure applied to the feed water in the one or more reverse osmosis vessels.

28. The system of claim 15, further comprising one or more output pumps coupled to the freshwater outlet for transporting the freshwater from the reverse osmosis vessels;

29. The system of claim 15, wherein each reverse osmosis vessel includes a plurality of tubular semipermeable membranes operating in series or in parallel.

30. The system of claim 29, wherein the tubular semipermeable membranes in the reverse osmosis vessel are arranged in a hexagonal lattice arrangement.
